(19) United States
(12) Patent Application Publication
(10) Pub. No.: US 2017/0320026 A1
(43) Pub. Date: Nov. 9, 2017

(54) Mixer for Viscous Fluids and Method of Mixing Viscous Fluids

(71) Applicant: Fast & Fluid Management B.V., Sassenheim (NL)

(72) Inventors: Martin Kruit, Voorhout (NL); Mark Baak, Lisse (NL); Nico Van Beelen, Katwijk (NL); Johannes Hermanus Nicolaas Post, Sassenheim (NL)

(73) Assignee: Fast & Fluid Management B.V., Sassenheim (NL)

(21) Appl. No.: 15/319,599

(22) PCT Filed: Jun. 17, 2015
(86) PCT No.: PCT/EP2015/063653

§ 371 Date: Dec. 16, 2016

Related U.S. Application Data
(60) Provisional application No. 62/013,278, filed on Jun. 17, 2014.

(51) Int. Cl. B01F 11/00; B01F 15/00; B01F 9/00

(52) U.S. Cl. CPC B01F 11/0022; B01F 15/00253; B01F 15/00129; B01F 15/00389; B01F 9/0001; B01F 15/00733

(57) ABSTRACT

The invention relates to a mixer, in particular for mixing viscous fluids, such as paints and plasters, in a container, the mixer comprising a frame, a clamping mechanism for holding a container, which mechanism is translatably and/or rotatably mounted in the frame, a motor for translatably and/or rotatably driving the clamping mechanism a sensor for measuring vibrations of the clamping mechanism, and a controller connected to the sensor and the motor and arranged to control the motor to adjust translations and/or rotations of the clamping mechanism in dependence of the measured vibrations.

### TECHNICAL FIELD

The invention relates to a mixer, in particular for mixing viscous fluids, such as paints and plasters, in a container, the mixer comprising a frame, a clamping mechanism for holding a container, which mechanism is translatably and/or rotatably mounted in the frame, and a motor for translatably and/or rotatably driving the clamping mechanism to mix the fluid. The invention also relates to a method of mixing materials, in particular viscous fluids, such as paints and plasters, in a container.

### BACKGROUND ART

EP 1 525 914 A2 relates to a gyroscopic mixer (indicated by numeral 10 in the Figures of EP 1 525 914 A2) which features a direct drive connection to a motor (11) and a clamping mechanism which enables the mixer to accommodate containers (51) of various sizes and configurations. The motor is connected to a drive shaft which is connected to a first bracket (16). The motor imparts rotation to the bracket (16) about a first axis (28). An annular gear (32) and single pulley belt is utilized to impart rotation about a second axis (38) that is substantially perpendicular to the first axis for a gyroscopic mixing motion.

U.S. Pat. No. 5,268,620 relates to a control system for mixing materials in a container. A screw-driven pressure plate clamps the container during mixing. The current of the clamping motor driving the screws is monitored and control circuitry allows multiple speed, multiple current draw, automatic switch-over operation of the clamping motor. Circuit components are automatically checked, and control over a mixing or clamping operation is assumed if necessary.

Mixers, such as shakers and biaxial gyroscopic mixers, for e.g. paint cans typically suffer from a degree of instability, especially when operated at higher frequencies. Vibrations usually increase with speed, can size and can weight. Conventional solutions to increase stability and reduce vibrations are: static balancing of the clamping mechanism, adding mass at base frame, reducing operating speed, in particular with large paint cans, providing special machine floor mounts, and avoiding resonance frequencies.

As it is unknown what variations, such as variations in kind, shape and number of cans, paint quality, filling degree, etc., will be introduced during a cycle, in current mixers, mixing speed is set well below theoretical or empirical maximum.

### SUMMARY OF THE DISCLOSURE

It is an object of the present invention to provide an improved mixer, which provides faster mixing and/or reduced vibrations during operation and/or is more energy efficient.

To this end, the mixer according to the present invention comprises a sensor for measuring vibrations of the clamping mechanism and a controller connected to the sensor and the motor and arranged to control the motor to adjust translations and/or rotations of the clamping mechanism in dependence of the measured vibrations.

Information derived from the vibrations can be employed for example to increase mixing efficiency, e.g. to assess when mixing is completed and thus shorten duration of mixing. In another example, the information is used during installation and/or service to provide an indication of the stability of placement of the mixer and provide instructions to adjust the support of the mixer, e.g. the leveling feet.

In an embodiment, the controller is arranged to increase the frequency of the translations and/or rotations until a parameter of the measured vibrations, e.g. amplitude or resonance, reaches a pre-selected threshold. Thus, the mixers can be operated at increased frequencies.

In another embodiment, the controller is arranged to decrease the frequency of the translations and/or rotations when a parameter of the measured vibrations reaches a pre-selected threshold.

By establishing e.g. undesirable resonance in the mixer or whether the container is slipping from the clamping mechanism, fails or leaks, the risk of incidents is reduced and safety increased. In a refinement, the controller is arranged to stop the mixing and/or to generate a warning signal when a parameter of the measured vibrations reaches a pre-selected threshold.

In another embodiment, the controller is arranged to derive from the measured vibrations the weight and/or the size of the container held in de clamping mechanism. Optionally, the height of the can is also included in estimating the weight and/or the size of the container. In a clamping mechanism comprising a pair of clamping plates, the height of the can typically corresponds to the distance between the plates.

In a refinement, the controller is arranged to estimate the energy required for adequate mixing and to estimate, based on measured vibrations, the energy (joules) inputted into the container. This enables a further reduction of the duration of the mixing, e.g. by stopping the mixing when the estimated energy input reaches the estimated energy required.

In an embodiment, the controller comprises a memory and the controller is arranged to store one or more parameters of the measured vibrations over time. Stored information may provide instructions for maintenance and/or an indication of wear. In a refinement, frequencies where resonance occurred are stored and the controller is arranged to avoid stationary operation at or near such frequencies.

In another embodiment, the sensor comprises a strain gauge, e.g. secured to the frame when deformations in the frame are sufficiently known, or, preferably, an accelerometer and/or a gyroscope, preferably an accelerometer and a gyroscope. In a refinement, the sensor comprises a motion tracking device combining a 3-axis gyroscope and a 3-axis accelerometer.

In another embodiment, the mixer comprises a sub-frame that is resiliently mounted in the frame, the clamping mechanism and preferably also the motor is (are) mounted in the sub-frame, and the sensor or at least one of the sensors is positioned on the sub-frame.

The invention further relates to a method of mixing viscous fluids, such as paints and plasters, in a container, by means of a mixer comprising a frame, a clamping mechanism for holding a container, which mechanism is translatably and/or rotatably mounted in the frame, the method comprising the steps of securing a container holding the fluid in the clamping mechanism, translating and/or rotating the mechanism, e.g. shaking and/or gyroscopically rotating the mechanism, measuring vibrations of the clamping mechanism and adjusting driving of the clamping mechanism in dependence of the measured vibrations.

In an embodiment, the method comprises increasing the frequency of translating and/or rotating until a parameter of the measured vibrations, e.g. amplitude or resonance, reaches a pre-selected value.

In another embodiment, the method comprises decreasing the frequency of translating and/or rotating or stopping the clamping mechanism when a parameter of the measured vibrations reaches a pre-selected value.

In yet another embodiment, the method comprises deriving from the measured vibrations the weight and/or the size of the container held in de clamping mechanism.

In a refinement, the method comprises estimating the energy required for adequate mixing of the fluid in the container and estimating, based on measured vibrations, the energy inputted into the container.

WO 2007/095060 relates to a mixing bin for the blending of materials (e.g., pharmaceuticals, foodstuffs, etc.) bears a spectrometer which monitors the characteristics of the material being tumbled within the bin interior to thereby obtain an indication of the degree to which the material is mixed. An accelerometer also rides on the mixing bin with the spectrometer, and it monitors the position of the mixing bin as it rotates. The accelerometer measurements can then be used to trigger the taking and/or recordation of spectrometer measurements at times during which the material within the bin falls against the spectrometer's input window, thereby promoting greater accuracy in spectrometer measurements, and/or at the same bin position, thereby promoting greater uniformity between spectrometer measurements.

### BRIEF DESCRIPTION OF THE DRAWINGS

The disclosed invention will be further explained with reference to the accompanying drawings in which presently preferred embodiments of the invention are shown schematically.

FIG. 1 is a perspective front view of a biaxial gyroscopic mixer according to the present invention.

FIG. 2 is a perspective rear view of the biaxial gyroscopic mixer shown in FIG. 1.

FIG. 3 is a cross-sectional side view of a clamping mechanism mounted of the biaxial gyroscopic mixer shown in FIGS. 1 and 2.

FIG. 4 is a perspective front view of a shaker according to the present invention.

### DETAILED DESCRIPTION OF THE PRESENTLY PREFERRED EMBODIMENTS

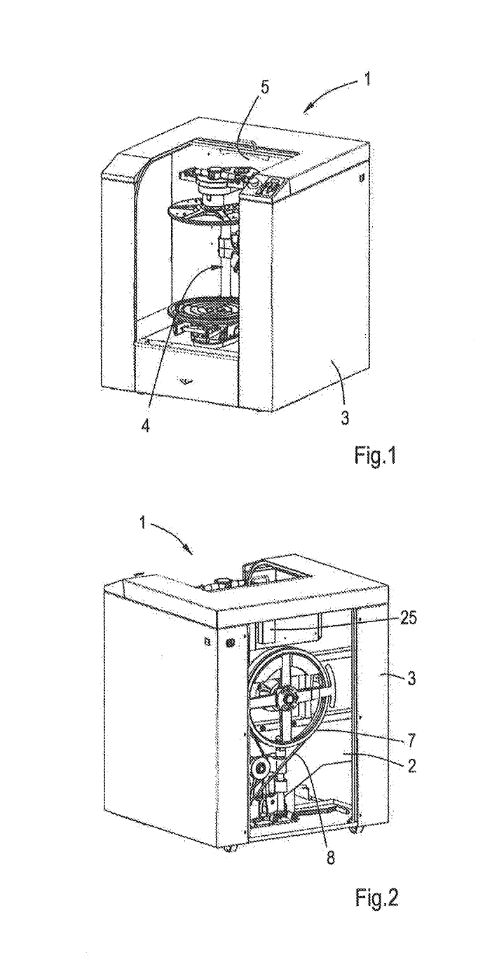

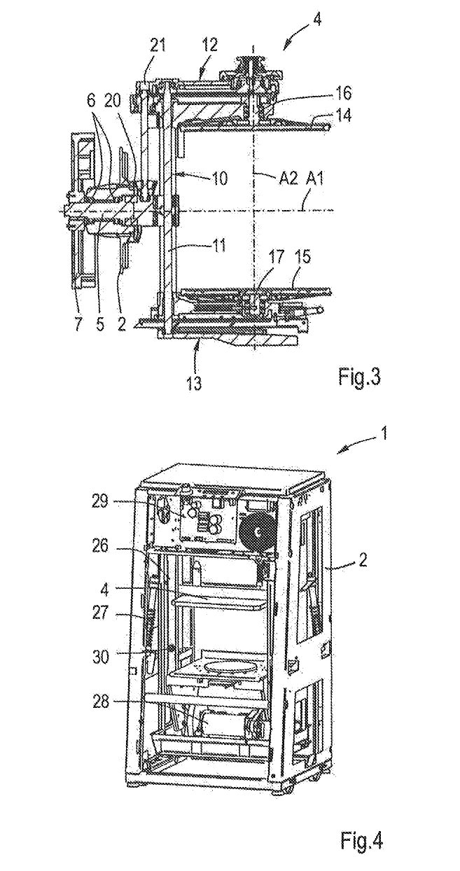

FIGS. 1 and 2 show a biaxial gyroscopic mixer 1 for mixing viscous fluids, such as paints and plasters, in a container (not shown). The mixer comprises a frame 2, metal sheets 3 attached to the frame and forming the exterior, a clamping mechanism 4 for receiving and securing a container, a sliding door 5 to screen off the clamping mechanism, and a motor (hidden from view) for driving the clamping mechanism. The clamping mechanism, shown in more detail in FIG. 3, comprises a horizontal first shaft 5 rotatably mounted in the frame by means of one or more bearings 6 about a first axis A1, a pulley 7, typically on the rear side of the bearing for driving the first shaft via a belt 8 and a further pulley on the motor, and, on the front side of the bearing and mounted on front end of the first shaft, a bracket, in this example a substantially c-shaped bracket 10, also known as “cradle”. The bracket comprises a central beam 11 and two arms 12, 13 extending perpendicular to the beam and parallel with the first axis. The arms carry clamping plates 14, 15 for securing containers of various sizes and shapes and, to this end, are slidable along the beam and towards each other, typically via a mechanism that maintains a substantially equal distance of both plates to first axis (so as to prevent introducing vibrations). The clamping plates are rotatable about a common second axis A2, e.g. by means of shafts 16, 17 mounted in the arms 12, 13 e.g. via bearings. The clamping mechanism further comprises, in a manner known in itself, bevel gears 20 and a set 21 of pulleys and a belt to couple rotation of the clamping plates and shafts about the second axis to rotation of the clamping mechanism about the first axis.

A controller 25 is mounted on the frame of the mixer. In this example, the controller comprises a printed circuit board (PCB) with components for driving the motor mounted on the PCB. A sensor, i.c. a motion tracking device combining a 3-axis gyroscope and a 3-axis accelerometer, is also mounted directly on the PCB.

FIG. 4 shows a shaker 1 for mixing viscous fluids, comprising a frame 2, a sub-frame 26 that is resiliently mounted in the frame via a plurality of springs 27 and dampers, a clamping mechanism 4 for receiving and securing a container mounted in the sub-frame, and a motor 28 plus eccenter for shaking the sub-frame and the clamping mechanism, all in principle similar to the shaker disclosed in U.S. Pat. No 5,268,620.

A controller is mounted on the frame 2 of the shaker and comprises a printed circuit board (PCB) 29 with components for driving the motor mounted on the PCB. A sensor 30, i.c. a motion tracking device combining a 3-axis gyroscope and a 3-axis accelerometer, is mounted on the sub-frame and connected to the controller.

During operation, a container holding the fluid is secured in the clamping mechanism, the clamping mechanism and the container are shaken (FIG. 4) and gyroscopically rotated (FIGS. 1 to 3), respectively, and vibrations of the clamping mechanism are measured, directly, i.c. on the sub-frame (FIG. 4) and clamping mechanism, or indirectly, i.c. on the frame (FIGS. 1 to 3). Driving of the clamping mechanism is adjusted in dependence of the measured vibrations.

As a matter of course, the invention is not restricted to the above-disclosed embodiment and can be varied in numerous ways within the scope of the claims.

1. A mixer, in particular for mixing viscous fluids, such as paints and plasters, in a container, the mixer comprising a frame, a clamping mechanism for holding a container, which mechanism is translatably and/or rotatably mounted in the frame, and a motor for translatably and/or rotatably driving the clamping mechanism, a sensor for measuring vibrations of the clamping mechanism and a controller connected to the sensor and the motor and arranged to control the motor to adjust translations and/or rotations of the clamping mechanism in dependence of the measured vibrations.

2. The mixer according to claim 1, wherein the controller is arranged to increase the frequency of the translations and/or rotations until a parameter of the measured vibrations reaches a pre-selected threshold.

3. The mixer according to claim 1, wherein the controller is arranged to decrease the frequency of the translations and/or rotations when a parameter of the measured vibrations reaches a pre-selected threshold.

4. The mixer according to claim, wherein the controller is arranged to derive from the measured vibrations the weight and/or the size of the container held in de clamping mechanism

5. The mixer according to claim 4, wherein the controller is arranged to estimate the energy required for adequate mixing and to estimate, based on measured vibrations, the energy inputted into the container.

6. The mixer according to claim 1, wherein the controller comprises a memory and the controller is arranged to store one or more parameters of the measured vibrations over time.

7. The mixer according to claim, wherein the sensor comprises a strain gauge, an accelerometer and/or a gyroscope, preferably comprises an accelerometer and a gyroscope.

8. The mixer according to claim, wherein the sensor comprises at least two axes, preferably three axes, and wherein the axes are arranged normal to each other.

9. The mixer according to claim, wherein the sensor or at least one of the sensors is positioned on the frame or on the clamping mechanism.

10. The mixer according to claim, comprising a sub-frame that is resiliently mounted in the frame, wherein the clamping mechanism is mounted in a sub-frame and wherein the sensor or at least one of the sensors is positioned on the sub-frame.

11. A method of mixing viscous fluids, such as paints and plasters, in a container, by means of a mixer comprising a frame, a clamping mechanism for holding a container, which mechanism is translatably and/or rotatably mounted in the frame, the method comprising the steps of securing a container holding the fluid in the clamping mechanism, translating and/or rotating the mechanism and the container, measuring vibrations of the clamping mechanism and the container and adjusting driving of the clamping mechanism in dependence of the measured vibrations.

12. The method according to claim 11, comprising increasing the frequency of translating and/or rotating until a parameter of the measured vibrations reaches a pre-selected value.

13. The method according to claim 11, comprising decreasing the frequency of the translating and/or rotating or stopping the clamping mechanism when a parameter of the measured vibrations reaches a pre-selected value.

14. The method according to claim 11, comprising deriving from the measured vibrations the weight and/or the size of the container held in de clamping mechanism.

15. The method according to claim 14, comprising estimating the energy required for adequate mixing of the fluid in the container and estimating, based on measured vibrations, the energy inputted into the container.
